(19) United States
(12) Patent Application Publication
(10) Pub. No.: US 2026/0291237 A1
(43) Pub. Date: Sep. 24, 2026

(54) CONTROL DEVICE FOR ENERGY POWER STORAGE SYSTEM, ENERGY POWER STORAGE SYSTEM, CONTROL METHOD FOR ENERGY POWER STORAGE SYSTEM, AND PROGRAM

(71) Applicant: MITSUBISHI HEAVY INDUSTRIES, LTD., Tokyo (JP)

(72) Inventors: Ryo IIDA, Tokyo (JP); Kazuhiko OKINO, Tokyo (JP)

(73) Assignee: MITSUBISHI HEAVY INDUSTRIES, LTD., Tokyo (JP)

(21) Appl. No.: 19/168,239

(22) PCT Filed: Oct. 3, 2023
(86) PCT No.: PCT/JP2023/036031

§ 371 Date: Sep. 23, 2025

(30) Foreign Application Priority Data
Mar. 31, 2023 (JP) 2023-057839

(51) Int. Cl. H02J 3/32; H02J 7/04; H02J 7/34; H02J 7/50; H02J 7/82

(52) U.S. Cl. CPC H02J 3/32; H02J 7/04; H02J 7/34; H02J 7/50; H02J 7/82; H02J 2207/20

(57) ABSTRACT

This control device for an energy power storage system is for an energy power storage system in which a plurality of storage battery units, each storage battery unit having a storage battery and a DC/DC converter that converts a voltage of charge/discharge electric power with respect to the storage battery, are connected in parallel via a DC bus, the control device comprising: a droop characteristics adjustment unit that adjusts an intercept of droop characteristics of a target unit, which is at least one storage battery unit of the plurality of storage battery units, when said target unit is charged or discharged with a desired electric power; and a limit-value-changing unit that changes the limit value of electric power that is input or output to or from the target unit to the desired electric power.

### TECHNICAL FIELD

The present disclosure relates to a control device for an energy power storage system, an energy power storage system, a control method for an energy power storage system, and a program.

This application claims priority based on Japanese Patent Application No. 2023-057839 filed in Japan on Mar. 31, 2023, and this content is incorporated herein by reference.

### BACKGROUND ART

In recent years, energy power storage systems have been used in various facilities such as power generation facilities and factories that use renewable energy. The energy power storage system includes a plurality of storage battery units each having a storage battery and a DC/DC converter, a power conditioning system (PCS), and a DC bus that connects the storage battery unit and the PCS.

For example, in a case where the electric power of the electric power system is insufficient, the energy power storage system supplies electric power discharged from the storage battery to the electric power system via the PCS. At this time, the discharge electric power (load sharing) of each storage battery unit may be adjusted such that the state of charge (SOC) of each storage battery is approximately uniform. As a technique for equalizing load sharing, PTL 1 and PTL 2 disclose that droop control is performed to change droop characteristics and adjust an output voltage, thereby equalizing load sharing between a generator and a storage battery or load sharing between power supply devices.

### CITATION LIST

### Patent Literature

[PTL 1] Japanese U.S. Pat. No. 3,679,949
[PTL 2] Japanese Unexamined Patent Application Publication No. 2011-10442

### SUMMARY OF INVENTION

### Technical Problem

When a difference occurs in SOC between storage batteries of a storage battery system or when the state of health (SOH) of a storage battery is measured, there is a case where only some of the storage batteries are charged or discharged with desired electric power. In the droop control in the related art, the charge/discharge amount of the storage battery changes according to the DC bus voltage. Therefore, it is difficult to charge and discharge at desired electric power. Therefore, in the energy power storage system in the related art, when charging and discharging the storage battery with desired electric power, it is necessary to switch from the droop control of the DC voltage to the current control (switching of the control mode). It is desirable that the charge/discharge electric power of only some of the storage batteries can be optionally adjusted by a method simpler than switching the control mode.

An object of the present disclosure is to provide a control device for an energy power storage system, an energy power storage system, a control method for an energy power storage system, and a program, in which the charge/discharge electric power of only some of the storage batteries of an energy power storage system can be optionally adjusted without switching a control mode.

### Solution to Problem

According to an aspect of the present disclosure, there is provided a control device for an energy power storage system in which a plurality of storage battery units, each having a storage battery and a DC/DC converter that converts a voltage of charge/discharge electric power with respect to the storage battery, are connected in parallel via a DC bus, the control device including: a droop characteristics adjustment unit that adjusts an intercept of droop characteristics of a target unit, which is at least one storage battery unit among the plurality of storage battery units, when the target unit is charged or discharged with desired electric power; and a limit value changing unit that changes a limit value of electric power that is input to or output from the target unit to the desired electric power.

According to another aspect of the present disclosure, there is provided an energy power storage system including: a plurality of storage battery units, each having a storage battery and a DC/DC converter that converts a voltage of charge/discharge electric power with respect to the storage battery; and the above-described control device.

According to still another aspect of the present disclosure, there is provided a control method for an energy power storage system in which a plurality of storage battery units, each having a storage battery and a DC/DC converter that converts a voltage of charge/discharge electric power with respect to the storage battery, are connected in parallel via a DC bus, the control method including: a step of adjusting an intercept of droop characteristics of a target unit, which is at least one storage battery unit among the plurality of storage battery units, when the target unit is charged or discharged with desired electric power; and a step of changing a limit value of electric power that is input to or output from the target unit.

According to still another aspect of the present disclosure, there is provided a program that causes a control device of an energy power storage system in which a plurality of storage battery units, each having a storage battery and a DC/DC converter that converts a voltage of charge/discharge electric power with respect to the storage battery, are connected in parallel via a DC bus, to execute a step of adjusting an intercept of droop characteristics of a target unit, which is at least one storage battery unit among the plurality of storage battery units, when the target unit is charged or discharged with desired electric power, and a step of changing a limit value of electric power that is input to or output from the target unit.

### Advantageous Effects of Invention

According to the above-described aspect, the charge/discharge electric power of some of the storage batteries of the energy power storage system can be optionally adjusted without switching the control mode.

### BRIEF DESCRIPTION OF DRAWINGS

FIG. 1 is a diagram showing an overall configuration of an energy power storage system according to an embodiment.

FIG. 2 is a block diagram showing a functional configuration of a control device according to the embodiment.

FIG. 3 is a block diagram showing a functional configuration of a DC/DC converter according to an embodiment.

FIG. 4 is a flowchart showing an example of processing of the control device according to the embodiment.

FIG. 5 is a diagram showing an example of adjustment of droop characteristics according to the embodiment.

FIG. 6 is a diagram for describing an operation example of the energy power storage system according to the embodiment.

### DESCRIPTION OF EMBODIMENTS

### Overall Configuration of Energy Power Storage System

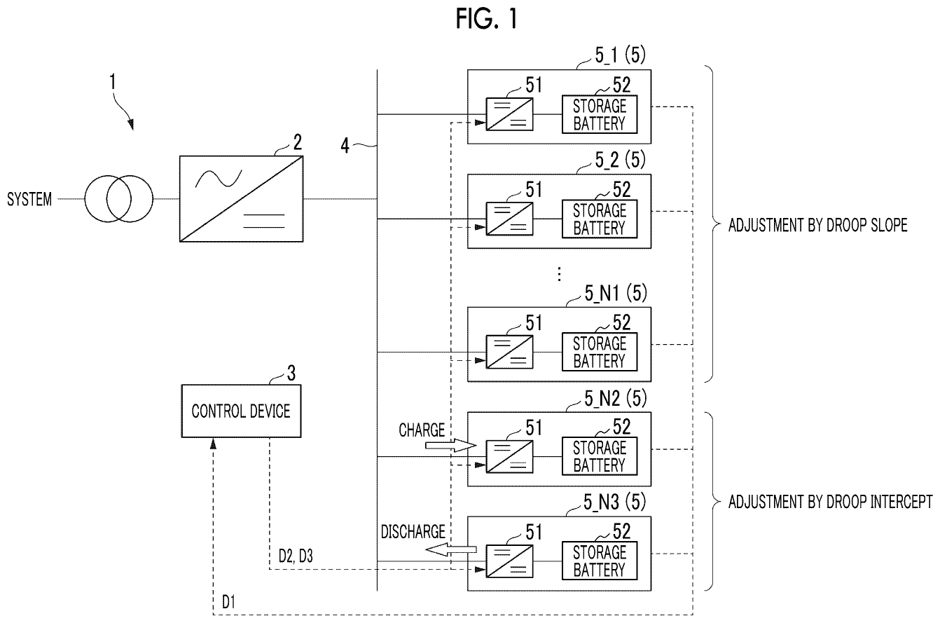

FIG. 1 is a diagram showing an overall configuration of an energy power storage system according to an embodiment.

As shown in FIG. 1, the energy power storage system 1 includes a power conditioning system (PCS) 2, a control device 3, a DC bus 4, and a plurality of storage battery units 5.

The PCS 2 is a power conditioner that is interconnected with an electric power system. The PCS 2 has a bidirectional inverter that converts AC power and DC power. The PCS 2 converts the DC power discharged from each storage battery unit 5 into AC power and outputs the AC power to the electric power system. In addition, the PCS 2 converts the AC power supplied from the electric power system into DC power and outputs the DC power to each storage battery unit 5.

The control device 3 controls the charging and discharging of each storage battery unit. The specific functional configuration of the control device 3 will be described later.

The DC bus 4 is a bus for connecting the PCS 2 and the plurality of storage battery units 5.

The plurality of storage battery units 5 are connected in parallel to the PCS 2 via the DC bus 4. Each storage battery unit 5 includes a DC/DC converter 51 and a storage battery 52. The DC/DC converter 51 converts the DC power supplied from the PCS 2 into a predetermined voltage and charges the storage battery 52 according to a command of the control device 3. In addition, the DC/DC converter 51 converts the discharge electric power of the storage battery 52 into a predetermined voltage and supplies the converted electric power to the PCS 2.

### Functional Configuration of Control Device

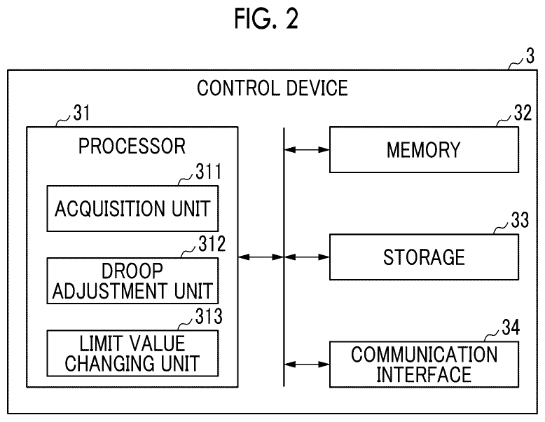

FIG. 2 is a block diagram showing a functional configuration of a control device according to the embodiment.

As shown in FIG. 2, the control device 3 includes a processor 31, a memory 32, a storage 33, and a communication interface 34.

The processor 31 functions as an acquisition unit 311, a droop characteristics adjustment unit 312, and a limit value changing unit 313 by operating according to a predetermined program.

The acquisition unit 311 acquires the battery information D1 indicating the state of the storage battery 52 from each of the plurality of storage battery units 5. The battery information D1 includes the SOC, cell voltage, temperature, and the like of the storage battery 52.

The droop characteristics adjustment unit 312 generates and transmits a droop characteristics setting D2 for performing droop control on each storage battery unit 5. The droop characteristics setting D2 includes a setting value of a slope (droop slope) and an intercept (droop intercept) of the droop characteristics of the storage battery unit 5.

In normal droop control, the droop slope is changed while the droop intercept of each storage battery unit 5 is fixed to an initial value (zero) to keep the voltage of the DC bus 4 constant and suppress variations in the state (SOC or the like) of each storage battery unit 5. In addition, the droop characteristics adjustment unit 312 according to the present embodiment performs, as a part of the droop control, processing of changing a droop intercept of a target unit when desired electric power is charged or discharged to and from the target unit which is at least one storage battery unit 5 among the plurality of storage battery units 5.

In addition, when the storage battery unit 5 that has been operated with the desired charge/discharge electric power is returned to the operation by the normal droop control (control only by the droop slope), the droop characteristics adjustment unit 312 generates and transmits the droop characteristics setting D2 for returning the droop intercept of the storage battery unit 5 to the initial value (zero).

The limit value changing unit 313 changes a limit value (lower limit value or upper limit value) of charge/discharge electric power for a storage battery unit (target unit) that is operated with desired charge/discharge electric power. In addition, the limit value changing unit 313 transmits the changed limit value to the target unit as an output power limit setting D3.

In addition, when the limit value changing unit 313 returns the storage battery unit 5 that has been operated with the desired charge/discharge electric power to the normal operation (control by the droop slope), the limit value of the charge/discharge electric power of the storage battery unit 5 is changed to the initial value.

The predetermined program executed by the processor 31 is stored in a computer-readable recording medium. In addition, examples of the computer-readable recording medium include a magnetic disk, a magneto-optical disk, a CD-ROM, a DVD-ROM, and a semiconductor memory. In addition, the computer program may be distributed to a computer via a communication line, and the computer receiving the distribution may execute the program. Further, the program may be a program for realizing some of the functions described above. Further, the program may be a so-called difference file (difference program) that can realize the functions described above in combination with a program already recorded in a computer system.

The memory 32 has a memory area necessary for the operations of the processor 31.

The storage 33 is a so-called auxiliary storage device and is, for example, a hard disk drive (HDD), a solid state drive (SSD), or the like. The storage 33 stores data that is acquired, generated, and referred to by each unit of the processor 31 during processing.

The communication interface 34 is an interface for transmitting and receiving various types of data and control signals (battery information D1, droop characteristics setting D2, and output power limit setting D3) between the communication interface 34 and each storage battery unit.

### Functional Configuration of DC/DC Converter

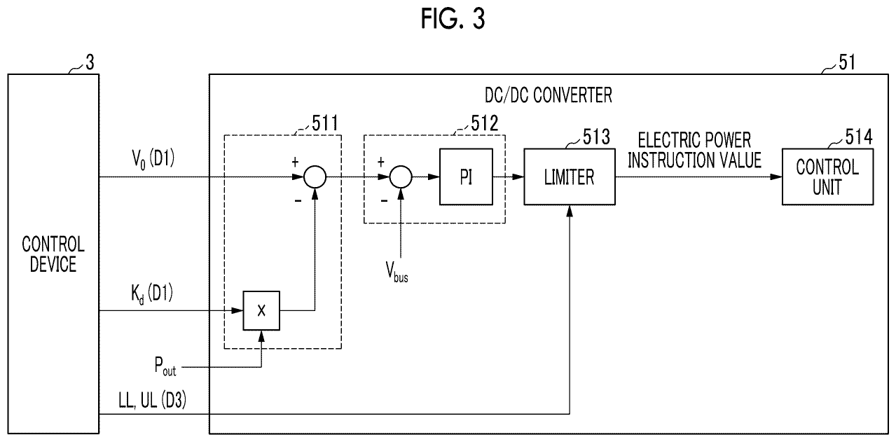

FIG. 3 is a block diagram showing a functional configuration of the DC/DC converter according to the embodiment. As shown in FIG. 3, the droop characteristics setting D2 and the output power limit setting D3 are input to the DC/DC converter 51 from the control device 3. The droop characteristics setting D2 includes a droop intercept Vo and a droop slope K_{d}. The output power limit setting D3 includes a lower limit value LL or an upper limit value UL of electric power.

In addition, the DC/DC converter 51 includes a calculation unit 511, an automatic voltage regulator (AVR) 512, a limiter 513, and a control unit 514.

The calculation unit 511 calculates the target voltage of the DC/DC converter 51 from the droop intercept V₀ and the droop slope K_{d} specified by the control device 3 and the output electric power Pₒᵤₜ which is a measured value of the output of the DC/DC converter 51. The calculation unit 511 gradually changes the droop intercept and the droop slope at a constant rate until the droop intercept V₀ and the droop slope K_{d} specified by the control device 3 are achieved. In this manner, the occurrence of a transient change in an overcurrent or a DC bus voltage due to a setting change is suppressed.

The AVR 512 inputs the difference between the target voltage and the DC bus voltage V_{bus}, which is a measured value of the voltage of the DC bus 4, to the PI controller to obtain an electric power command value indicating electric power corresponding to the voltage to be output by the DC/DC converter 51.

The limiter 513 limits the electric power command value not to fall below the lower limit value LL or to exceed the upper limit value UL set by the control device 3. The limiter 513 gradually changes the lower limit value or the upper limit value at a constant rate until the lower limit value LL or the upper limit value UL specified by the control device 3 is achieved. In this manner, it is possible to suppress the occurrence of overcurrent and transient fluctuations in the DC bus voltage associated with the setting change.

The control unit 514 controls the electric power that the DC/DC converter outputs to the PCS 2 side or the storage battery 52 side, based on the electric power command value after adjustment by the limiter 513.

### Processing Flow of Control Device

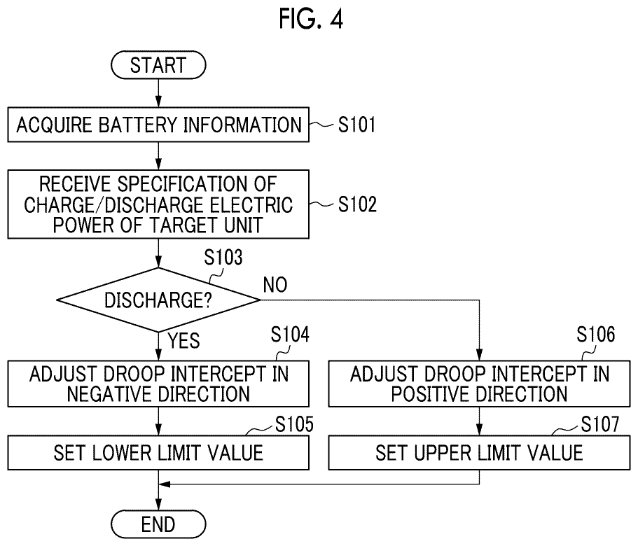

FIG. 4 is a flowchart showing an example of processing of the control device according to the embodiment.

Here, a processing flow in a case where the control device 3 operates some of the storage battery units 5 with desired charge/discharge electric power will be described with reference to FIG. 4.

The acquisition unit 311 acquires the battery information D1 from each storage battery unit 5 at each predetermined timing (step S101). The battery information D1 may be displayed on a monitor (not shown) of the control device 3, and may be always checkable by an administrator of the energy power storage system 1.

In addition, the droop characteristics adjustment unit 312 receives specification of the charge/discharge electric power of the storage battery unit 5 (target unit) from the administrator of the energy power storage system 1 (step S102).

For example, the administrator may check the battery information D1 of each storage battery unit 5, select the storage battery unit 5, of which SOC is significantly different from that of other units, as a target unit, and specify the charge/discharge electric power of the target unit. In addition, the administrator may select the storage battery unit 5, which measures the SOH, as the target unit, and specify the charge/discharge electric power that is specified in advance for SOH measurement.

Next, the droop characteristics adjustment unit 312 determines whether to charge or discharge the target unit (step S103). The droop characteristics adjustment unit 312 determines that the charging is performed in a case where a negative value is specified, and that the discharging is performed in a case where a positive value is specified, as the desired charge/discharge electric power for the target unit by, for example, the administrator. In addition, the charging or discharging may be specified by the administrator.

First, the processing during charging (step S103; processing after YES) will be described. For example, the target unit is a storage battery unit 5_N2 in FIG. 1, and charging of the target unit 5_N2 is performed with desired electric power. In a case where the target unit 5_N2 is charged (step S103; YES), the droop characteristics adjustment unit 312 adjusts the droop intercept of the target unit 5_N2 in the negative direction (step S104). In addition, the droop characteristics adjustment unit 312 transmits the adjusted droop intercept as the droop characteristics setting D2 to the target unit 5_N2.

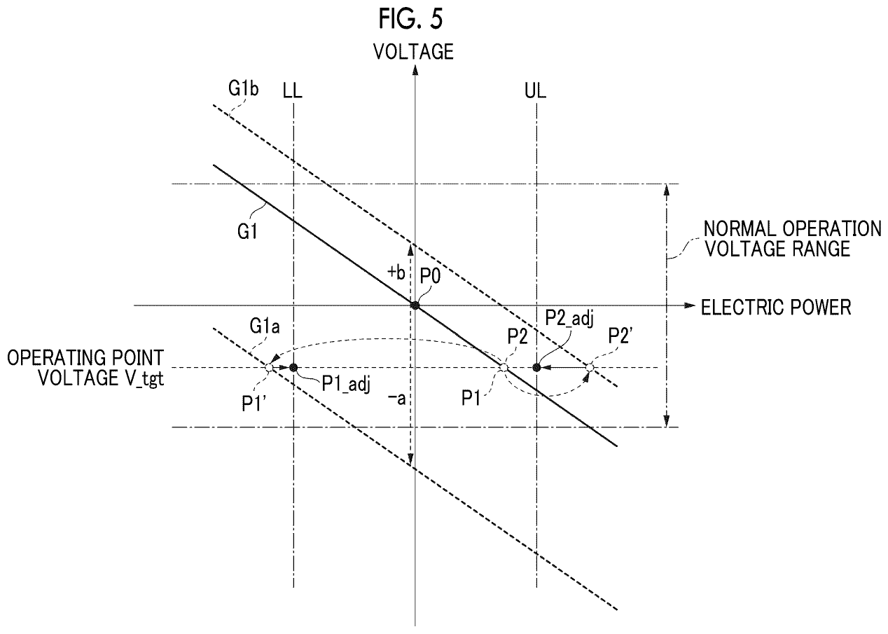

FIG. 5 is a diagram showing an example of adjustment of droop characteristics according to the embodiment.

FIG. 5 shows the droop characteristics of the target unit 5_N2. The vertical axis represents the output voltage of the target unit 5_N2, and the horizontal axis represents the output electric power of the target unit 5_N2. G1 is droop characteristics before adjustment of the target unit 5_N2. P0 represents output electric power at no load (rated voltage). This indicates that the greater the output electric power becomes to the right side of P0, the greater the electric power output (discharged) from the target unit 5_N2 to the PCS 2 becomes. In addition, this indicates that the greater the output electric power becomes to the left side of P0, the greater the electric power input (charged) from the PCS 2 to the target unit 5_N2 becomes.

During charging, the droop characteristics adjustment unit 312 adjusts the intercept of the droop characteristics G1 of the target unit 5_N2 in the negative direction (rated voltage: −a). The adjustment amount −a of the droop intercept may be a fixed value set in advance for each storage battery unit, or may be a value specified by the administrator of the energy power storage system 1 via the control device 3. G1a is the droop characteristics of the target unit 5_N2 adjusted in the negative direction.

Next, the limit value changing unit 313 changes the lower limit value LL of the target unit 5_N2 (step S105). In addition, the limit value changing unit 313 transmits the changed lower limit value LL to the target unit 5_N2 as the output power limit setting D3.

Specifically, the limit value changing unit 313 sets the charge electric power specified by the administrator of the energy power storage system 1 as the lower limit value LL after the change of the target unit 5_N2.

In another embodiment, the administrator may provide the control device 3 with a table in which desired charge electric power is set in advance according to the state (SOC, a combination of SOC and temperature, or the like) of the storage battery 52 of each storage battery unit 5. In this case, the limit value changing unit 313 reads the charge electric power corresponding to the current battery information D1 (SOC, temperature, or the like) of the target unit 5_N2 from the table, and automatically sets the charge electric power as the lower limit value LL after the change of the target unit 5_N2.

Next, the processing during discharge (step S103; processing after NO) will be described. In a case where the discharge is performed from the target unit 5_N2 (step S103; NO), the droop characteristics adjustment unit 312 adjusts the droop intercept of the target unit 5_N2 in the positive direction (step S106). In addition, the droop characteristics adjustment unit 312 transmits the adjusted droop intercept as the droop characteristics setting D2 to the target unit 5_N2.

As shown in FIG. 5, during discharging, the droop characteristics adjustment unit 312 adjusts the intercept of the droop characteristics G1 of the target unit 5_N2 in the positive direction (rated voltage: +b). The adjustment amount +b of the droop intercept may be a fixed value set in advance for each storage battery unit, or may be a value specified by the administrator of the energy power storage system 1 via the control device 3. G1b is the droop characteristics of the target unit 5_N2 adjusted in the positive direction.

Next, the limit value changing unit 313 changes the upper limit value UL of the target unit 5_N2 (step S107). In addition, the limit value changing unit 313 transmits the changed upper limit value UL to the target unit 5_N2 as the output power limit setting D3.

Specifically, the limit value changing unit 313 sets the discharge electric power specified by the administrator of the energy power storage system 1 as the upper limit value UL after the change of the target unit 5_N2.

In another embodiment, the administrator may provide the control device 3 with a table in which desired discharge electric power is set in advance according to the state (SOC, a combination of SOC and temperature, or the like) of the storage battery 52 of each storage battery unit 5. In this case, the limit value changing unit 313 reads the discharge electric power corresponding to the current battery information D1 (SOC, temperature, or the like) of the target unit 5_N2 from the table, and automatically sets the discharge electric power as the upper limit value UL after the change of the target unit 5_N2.

### Operation of DC/DC Converter

Next, the operation of the DC/DC converter 51 of the storage battery unit 5 will be described in detail. For example, it is assumed that the administrator of the energy power storage system 1 specifies the storage battery unit 5_N2 (target unit) to be operated with the desired charge electric power. In this case, the droop characteristics adjustment unit 312 of the control device 3 generates the droop characteristics setting D2 (G1a in FIG. 5) in which the droop intercept of the target unit 5_N2 is adjusted in the negative direction as in the example of FIG. 5, and transmits the droop characteristics setting D2 to the target unit 5_N2 (step S104 in FIG. 4). In addition, the limit value changing unit 313 of the control device 3 generates the output power limit setting D3 in which the lower limit value LL is changed to the charge electric power desired by the administrator, and transmits the output power limit setting D3 to the target unit 5_N2 (step S105 in FIG. 4).

In addition, as shown in FIGS. 3 and 5, the DC/DC converter 51 of the target unit 5_N2 obtains a target voltage (operating point voltage V_tgt) based on the droop characteristics setting D2 (droop slope, droop intercept) and the output electric power Pout of the DC/DC converter 51.

As shown in FIG. 5, in the droop characteristics G1 before adjustment, the output electric power of the DC/DC converter 51 is P1 at the operating point voltage V_tgt. Meanwhile, in the droop characteristics Gla after the adjustment, the output electric power is P1′. Since the output electric power P1′ falls below the lower limit value LL, the output electric power P1′ is finally adjusted to the output electric power P1_adj by the limiter 513 of the DC/DC converter 51, and becomes the electric power command value input to the control unit 514. That is, the output electric power P1_adj of the DC/DC converter 51 of the target unit 5_N2 coincides with the charge electric power specified by the administrator. In this manner, it is possible to charge the target unit 5_N2 with the desired electric power regardless of the voltage of the DC bus 4.

In addition, for example, it is assumed that the administrator of the energy power storage system 1 specifies the storage battery unit 5_N2 (target unit) to be operated with the desired discharge electric power. In this case, the droop characteristics adjustment unit 312 of the control device 3 generates the droop characteristics setting D2 (G1b in FIG. 5) in which the droop intercept of the target unit 5_N2 is adjusted in the positive direction as in the example of FIG. 5, and transmits the droop characteristics setting D2 to the target unit 5_N2 (step S106 in FIG. 4). In addition, the limit value changing unit 313 of the control device 3 generates the output power limit setting D3 in which the upper limit value UL is changed to the discharge electric power desired by the administrator, and transmits the output power limit setting D3 to the target unit 5_N2 (step S105 in FIG. 4).

As shown in FIG. 5, in the droop characteristics G1 before adjustment, the output electric power of the DC/DC converter 51 is P2 at the operating point voltage V_tgt. Meanwhile, in the droop characteristics G1b after the adjustment, the output electric power is P2′. Since the output electric power P2′ exceeds the upper limit value UL, the output electric power P2′ is finally adjusted to the output electric power P2_adj by the limiter 513 of the DC/DC converter 51, and becomes the electric power command value input to the control unit 514. That is, the output electric power P2_adj of the DC/DC converter 51 of the target unit 5_N2 coincides with the discharge electric power specified by the administrator. In this manner, it is possible to discharge the target unit 5_N2 with the desired electric power regardless of the voltage of the DC bus 4.

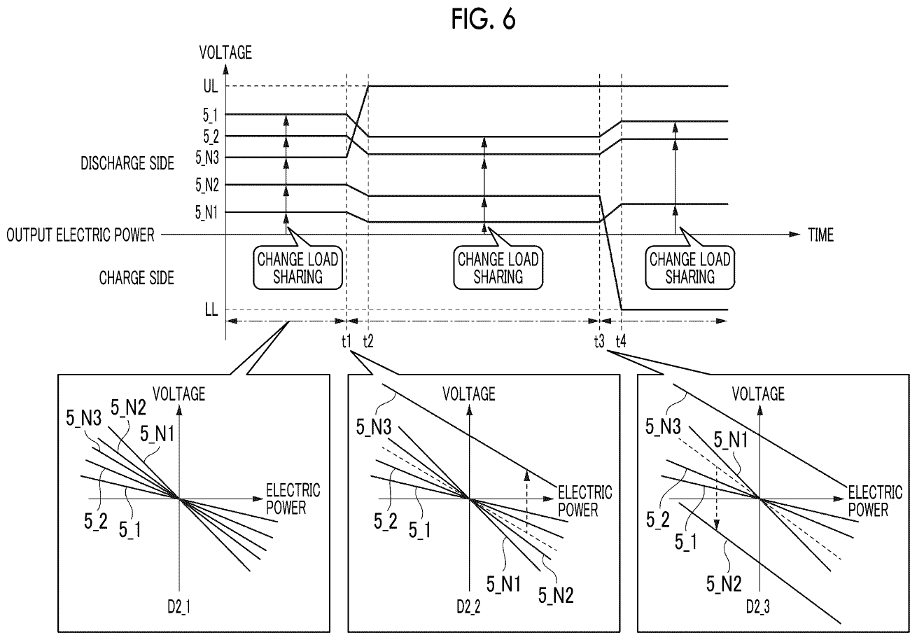

FIG. 6 is a diagram for describing an operation example of the energy power storage system according to the embodiment.

FIG. 6 shows a time series of output electric power of storage battery units 5_1, 5_2, 5_N1, 5_N2, and 5_N3 shown in FIG. 1 and an example of the droop characteristics setting D2 and the output power limit setting D3.

As shown in FIG. 6, until time t1, the control device 3 performs normal droop control to discharge electric power from each storage battery unit 5. At this time, the droop characteristics adjustment unit 312 of the control device 3 transmits the droop characteristics setting D2_1 in which the droop slope of each storage battery unit 5 is adjusted to keep the voltage of the DC bus 4 constant and suppress the variation in the SOC of each storage battery unit 5. In addition, the limit value changing unit 313 of the control device 3 transmits the output power limit setting D3 for keeping the electric power limit value (lower limit value LL and upper limit value UL) of each storage battery unit 5 as the initial value.

It is assumed that the control device 3 has received an instruction from the administrator of the energy power storage system 1 to discharge the storage battery unit 5_N3 with the specified electric power at time t1. In this case, the droop characteristics adjustment unit 312 of the control device 3 generates the droop characteristics setting D2_2 in which the droop intercept of the storage battery unit 5_N3 is changed in the positive direction, and transmits the droop characteristics setting D2_2 to the storage battery unit 5_N3 (step S106 in FIG. 4). In addition, the limit value changing unit 313 of the control device 3 generates the output power limit setting D3 in which the upper limit value UL of the storage battery unit 5_N3 is changed to the discharge electric power specified by the administrator, and transmits the output power limit setting D3 to the storage battery unit 5_N3 (step S107 in FIG. 4). The UL of FIG. 6 is an upper limit value set for the storage battery unit 5_N3.

In this case, as described above with reference to FIGS. 3 and 5, the DC/DC converter 51 of the storage battery unit 5_N3 outputs (discharges) the electric power at the discharge electric power specified by the administrator based on the droop characteristics setting D2 and the output power limit setting D3. At this time, the DC/DC converter 51 gradually changes the droop intercept V₀ and the upper limit value UL at a constant rate until the droop intercept V₀ and the upper limit value UL become the values specified by the droop characteristics setting D2_2 and the output power limit setting D3. Therefore, as shown in FIG. 6, the DC/DC converter 51 controls the output to be the discharge electric power specified by the administrator from time t1 to time t2.

In addition, the load (discharge electric power) that should be shared by the other storage battery units 5 is reduced by the amount of increase in the discharge electric power of the storage battery unit 5_N3. Therefore, the control device 3 adjusts the droop slope of each storage battery unit 5 by performing normal droop control (control based on a droop slope) on the other storage battery units 5_1, 5_2, 5_N1, and 5_N2 to change the load sharing.

In addition, it is assumed that the control device 3 has received an instruction from the administrator of the energy power storage system 1 to charge the storage battery unit 5_N2 with the specified electric power at time t3. In this case, the droop characteristics adjustment unit 312 of the control device 3 generates the droop characteristics setting D2_3 in which the droop intercept of the storage battery unit 5_N2 is changed in the negative direction, and transmits the droop characteristics setting D2_3 to the storage battery unit 5_N2 (step S104 in FIG. 4). In addition, the limit value changing unit 313 of the control device 3 generates the output power limit setting D3 in which the lower limit value LL of the storage battery unit 5_N2 is changed to the charge electric power specified by the administrator, and transmits the output power limit setting D3 to the storage battery unit 5_N2 (step S105 in FIG. 4). The LL of FIG. 6 is a lower limit value set for the storage battery unit 5_N2.

In this case, as described above with reference to FIGS. 3 and 5, the DC/DC converter 51 of the storage battery unit 5_N2 outputs (charges) the electric power to the storage battery 52 at the charge electric power specified by the administrator based on the droop characteristics setting D2 and the output power limit setting D3. At this time, the DC/DC converter 51 gradually changes the droop intercept V₀ and the lower limit value LL at a constant rate until the droop intercept V₀ and the lower limit value LL become the values specified by the droop characteristics setting D2_3 and the output power limit setting D3. Therefore, as shown in FIG. 6, the DC/DC converter 51 controls the output to be the charge electric power specified by the administrator from time t3 to time t4.

In addition, the load (discharge electric power) that should be shared by the other storage battery units 5 increases by the amount of increase in the charge electric power of the storage battery unit 5_N2. Therefore, the control device 3 adjusts the droop slope of each storage battery unit 5 by the normal droop control for the other storage battery units 5_1, 5_2, and 5_N1 to change the load sharing.

### Operations and Effects

As described above, the control device 3 of the energy power storage system 1 according to the present embodiment includes: the droop characteristics adjustment unit 312 that adjusts the intercept of the droop characteristics of the target unit when charging and discharging the desired electric power to and from the target unit, which is at least one storage battery unit 5 among the plurality of storage battery units 5; and the limit value changing unit 313 that changes the limit value of the electric power input and output by the target unit.

As described above, in the related art, in a case where only a specific storage battery unit (target unit) is charged or discharged with desired electric power, it is necessary to switch a control mode from droop control to current control. In contrast, the control device 3 according to the present embodiment can operate the target unit at any charge/discharge electric power without switching the control mode, that is, while the control is being performed by the droop control, by the droop characteristics adjustment unit 312 and the limit value changing unit 313 changing the droop intercept and the limit value of the charge/discharge electric power.

In addition, the control device 3 further includes the acquisition unit 311 that acquires the battery information D1 indicating a state of the storage battery 52 from each of the plurality of storage battery units 5. The limit value changing unit 313 reads desired electric power corresponding to the battery information D1 of the target unit from a table in which desired electric power is set in advance in accordance with the state of the storage battery 52 of the storage battery unit 5, and sets the desired electric power as a limit value of the target unit.

In this manner, the control device 3 can automatically adjust the charging and discharging with the desired electric power set in advance in accordance with the state of the storage battery 52 of the target unit. Accordingly, the load on the administrator can be reduced.

In addition, the droop characteristics adjustment unit adjusts an intercept of the droop characteristics in a negative direction when the target unit is charged, and adjusts the intercept of the droop characteristics in a negative direction when the target unit is discharged.

In this manner, the control device 3 can appropriately adjust the target unit to be charged or discharged with the desired electric power (lower limit value LL or upper limit value UL).

In addition, the DC/DC converter 51 of the storage battery unit 5 gradually changes the intercept of the droop characteristics and the limit value (lower limit value LL or upper limit value UL) at a constant rate until a value set by the control device 3 is achieved.

In this manner, the storage battery unit 5 can suppress the occurrence of overcurrent and transient fluctuations in the DC bus voltage associated with the setting change by the control device 3.

As described above, the embodiments according to the present disclosure have been described. However, the above-described embodiments are presented as examples, and are not intended to limit the scope of the present disclosure. These embodiments can be implemented in various other embodiments, and various omissions, replacements, and changes can be made without departing from the gist of the present disclosure. These embodiments and variations thereof are included in the scope and equivalent of the present disclosure described in the claims as well as in the scope and abstract of the present disclosure.

### Supplementary Notes

The control device for an energy power storage system, the energy power storage system, the control method for an energy power storage system, and the program described in the above-described embodiment are understood as follows, for example.
(1) According to a first aspect, there is provided a control device 3 for an energy power storage system 1 in which a plurality of storage battery units 5, each having a storage battery 52 and a DC/DC converter 51 that converts a voltage of charge/discharge electric power with respect to the storage battery 52, are connected in parallel via a DC bus 4, the control device 3 including: a droop characteristics adjustment unit 312 that adjusts an intercept of droop characteristics of a target unit, which is at least one storage battery unit 5 among the plurality of storage battery units 5, when the target unit is charged or discharged with desired electric power; and a limit value changing unit 313 that changes a limit value of electric power that is input to or output from the target unit to the desired electric power.

As described above, in the related art, in a case where only a specific storage battery unit (target unit) is charged or discharged with desired electric power, it is necessary to switch a control mode from droop control to current control. In contrast, the control device 3 according to the present embodiment can operate the target unit at any charge/discharge electric power without switching the control mode, that is, while the control is being performed by the droop control, by the droop characteristics adjustment unit 312 and the limit value changing unit 313 changing the droop intercept and the limit value of the charge/discharge electric power.
(2) According to a second aspect, in the control device 3 for an energy power storage system 1 according to the first aspect, an acquisition unit 311 that acquires battery information D1 indicating a state of the storage battery 52 from each of the plurality of storage battery units 5, is further provided, and the limit value changing unit 313 reads desired electric power corresponding to the battery information D1 of the target unit from a table in which desired electric power corresponding to the state of the storage battery 52 is set in advance, and sets the desired electric power as the limit value of the target unit.

In this manner, the control device 3 can automatically adjust the charging and discharging with the desired electric power set in advance in accordance with the state of the storage battery 52 of the target unit. Accordingly, the load on the administrator can be reduced.
(3) According to a third aspect, in the control device 3 for an energy power storage system 1 according to the first or second aspect, the droop characteristics adjustment unit 312 adjusts the intercept of the droop characteristics in a negative direction when the target unit is charged, and adjusts the intercept of the droop characteristics in a positive direction when the target unit is discharged.

In this manner, the control device 3 can appropriately adjust the target unit to be charged or discharged with the desired electric power (lower limit value LL or upper limit value UL).
(4) According to a fourth aspect, there is provided an energy power storage system 1 including: a plurality of storage battery units 5, each having a storage battery 52 and a DC/DC converter 51 that converts a voltage of charge/discharge electric power with respect to the storage battery 52; and the control device 3 according to any one of the first to third aspects.

In this manner, the energy power storage system 1 can operate the target unit with any charge/discharge electric power without switching the control mode, that is, while the droop control is being performed.
(5) According to a fifth aspect, in the energy power storage system 1 according to the fourth aspect, the DC/DC converter 51 gradually changes the intercept of the droop characteristics and the limit value at a constant rate until a value set by the control device 3 is achieved.

In this manner, the storage battery unit 5 can suppress the occurrence of overcurrent and transient fluctuations in the DC bus voltage associated with the setting change by the control device 3.
(6) According to a sixth aspect, there is provided a control method for an energy power storage system 1 in which a plurality of storage battery units 5, each having a storage battery 52 and a DC/DC converter 51 that converts a voltage of charge/discharge electric power with respect to the storage battery 52, are connected in parallel via a DC bus 4, the control method including: a step of adjusting an intercept of droop characteristics of a target unit, which is at least one storage battery unit 5 among the plurality of storage battery units 5, when the target unit is charged or discharged with desired electric power; and a step of changing a limit value of electric power that is input to or output from the target unit.
(7) According to a seventh aspect, there is provided a program that causes a control device 3 of an energy power storage system 1 in which a plurality of storage battery units 5, each having a storage battery 52 and a DC/DC converter 51 that converts a voltage of charge/discharge electric power with respect to the storage battery 52, are connected in parallel via a DC bus 4, to execute a step of adjusting an intercept of droop characteristics of a target unit, which is at least one storage battery unit 5 among the plurality of storage battery units 5, when the target unit is charged or discharged with desired electric power, and a step of changing a limit value of electric power that is input to or output from the target unit.

### Industrial Applicability

According to the above-described aspect, the charge/discharge electric power of some of the storage batteries of the energy power storage system can be optionally adjusted without switching the control mode.

### REFERENCE SIGNS LIST

1 Energy power storage system
2 PCS
3 Control device
31 Processor
311 Acquisition unit
312 Droop characteristics adjustment unit
313 Limit value changing unit
32 Memory
33 Storage
34 Communication interface
4 DC bus
5 Storage battery unit
51 DC/DC converter
511 Calculation unit
512 AVR
513 Limiter
514 Control unit
52 Storage battery
D1 Battery information
D2 Droop characteristics setting
D3 Output power limit setting

1. A control device for an energy power storage system in which a plurality of storage battery units, each having a storage battery and a DC/DC converter that converts a voltage of charge/discharge electric power with respect to the storage battery, are connected in parallel via a DC bus, the control device comprising:
a droop characteristics adjustment unit that adjusts an intercept of droop characteristics of a target unit, which is at least one storage battery unit among the plurality of storage battery units, when the target unit is charged or discharged with desired electric power; and
a limit value changing unit that changes a limit value of electric power that is input to or output from the target unit to the desired electric power.

2. The control device for an energy power storage system according to claim 1, further comprising:
an acquisition unit that acquires battery information indicating a state of the storage battery from each of the plurality of storage battery units, wherein
the limit value changing unit reads desired electric power corresponding to the battery information of the target unit from a table in which desired electric power corresponding to the state of the storage battery is set in advance, and sets the desired electric power as the limit value of the target unit.

3. The control device for an energy power storage system according to claim 1, wherein
the droop characteristics adjustment unit
adjusts the intercept of the droop characteristics in a negative direction when the target unit is charged, and
adjusts the intercept of the droop characteristics in a positive direction when the target unit is discharged.

4. An energy power storage system comprising:
a plurality of storage battery units, each having a storage battery and a DC/DC converter that converts a voltage of charge/discharge electric power with respect to the storage battery; and
the control device according to claim 1.

5. The energy power storage system according to claim 4, wherein
the DC/DC converter gradually changes the intercept of the droop characteristics and the limit value at a constant rate until a value set by the control device is achieved.

6. A control method for an energy power storage system in which a plurality of storage battery units, each having a storage battery and a DC/DC converter that converts a voltage of charge/discharge electric power with respect to the storage battery, are connected in parallel via a DC bus, the control method comprising:
a step of adjusting an intercept of droop characteristics of a target unit, which is at least one storage battery unit among the plurality of storage battery units, when the target unit is charged or discharged with desired electric power; and
a step of changing a limit value of electric power that is input to or output from the target unit.

7. A program that causes a control device of an energy power storage system in which a plurality of storage battery units, each having a storage battery and a DC/DC converter that converts a voltage of charge/discharge electric power with respect to the storage battery, are connected in parallel via a DC bus, to execute
a step of adjusting an intercept of droop characteristics of a target unit, which is at least one storage battery unit among the plurality of storage battery units, when the target unit is charged or discharged with desired electric power, and
a step of changing a limit value of electric power that is input to or output from the target unit.

8. An energy power storage system comprising:
a plurality of storage battery units, each having a storage battery and a DC/DC converter that converts a voltage of charge/discharge electric power with respect to the storage battery; and
the control device according to claim 2.

9. An energy power storage system comprising:
a plurality of storage battery units, each having a storage battery and a DC/DC converter that converts a voltage of charge/discharge electric power with respect to the storage battery; and
the control device according to claim 3.
